(19) United States
(12) Patent Application Publication
(10) Pub. No.: US 2017/0249043 A1
(43) Pub. Date: Aug. 31, 2017

(54) TOUCH PANEL SURFACE TOUCH RECOGNITION METHOD AND SYSTEM

(71) Applicants: Shanghai AVIC OPTO Electronics Co., Ltd., Shanghai (CN); Tianma Micro-electronics Co., Ltd., Shenzhen (CN)

(72) Inventors: FENG QIN, Shanghai (CN); HUIJUN JIN, Shanghai (CN); DONGLIANG DUN, Shanghai (CN); ZHIQIANG XIA, Shanghai (CN); SHOUFU JIAN, Shanghai (CN); DANDAN QIN, Shanghai (CN)

(73) Assignees: Shanghai AVIC OPTO Electronics Co., Ltd.; Tianma Micro-electronics Co., Ltd.

(21) Appl. No.: 15/163,339

(22) Filed: May 24, 2016

(30) Foreign Application Priority Data
Feb. 29, 2016 (CN) 2016-10112711.7

(51) Int. Cl. G06F 3/041; G06F 17/30; G06F 3/044

(52) U.S. Cl. CPC G06F 3/0416; G06F 3/0414; G06F 3/044; G06F 17/30424

(57) ABSTRACT

The present disclosure provides a touch panel surface touch recognition method for a touch control device. The method includes acquiring real-time user touch parameters of a user touch; using the acquired real-time user touch parameters to query a pre-established database and to obtain a user touch parameter range corresponding to the acquired real-time user touch parameters; and recognizing an overall touch type based on the user touch parameter range. The pre-established database stores relationship data between pre-configured user touch types and user touch parameter ranges corresponding to the pre-configured user touch types; and different user touch parameter ranges correspond to different pre-configured touch types.

### CROSS-REFERENCES TO RELATED APPLICATIONS

This application claims the priority of Chinese Patent Application No. CN201610112711.7, filed on Feb. 29, 2016, the entire contents of which are incorporated herein by reference.

### FIELD OF THE DISCLOSURE

The present disclosure generally relates to the touch control technologies and, more particularly, relates to a touch panel surface touch recognition method and system.

### BACKGROUND

With the advancement of modern electronic technologies, more and more touch control devices are integrated with the pressure sensing function. A conventional touch control device often includes a deformation sensing module in the touch control device to detect the amount of deformation when the surface of the touch control device is heavily pressed by a user. Thus, the heavy pressure sensing is achieved.

However, the deformation sensing modules are often costly. Accordingly, the touch control devices incorporating such deformation sensing modules are also costly. The disclosed touch panel surface touch recognition method and system are directed to solve one or more problems in the art.

### BRIEF SUMMARY OF THE DISCLOSURE

Directed to solve one or more problems set forth above and other problems in the art, the present disclosure provides a method and a system for touch panel surface touch recognition.

One aspect of the present disclosure includes a touch panel surface touch recognition method for a touch control device. The method includes acquiring real-time user touch parameters of a user touch; using the acquired real-time user touch parameters to query a pre-established database and to obtain a user touch parameter range corresponding to the acquired real-time user touch parameters; and recognizing an overall touch type based on the user touch parameter range. The pre-established database stores relationship data between pre-configured user touch types and user touch parameter ranges corresponding to the pre-configured user touch types; and different user touch parameter ranges correspond to different pre-configured touch types.

Another aspect of the present disclosure includes a touch panel surface touch recognition system for a touch control device. The touch recognition system includes an acquisition module and a recognition module. The acquisition module is configured to acquire real-time user touch parameters of a user touch. The recognition module is configured to use the acquired real-time user touch parameters to query a pre-established database and to obtain a user touch parameter range corresponding to the acquired real-time user touch parameters; and to recognize an overall touch type based on the user touch parameter range. The pre-established database stores relationship data between pre-configured user touch types and user touch parameter ranges corresponding to the pre-configured user touch types; and different user touch parameter ranges correspond to different pre-configured touch types.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a flow chart of an exemplary touch panel surface touch recognition method according to the disclosed embodiments;

FIG. 2 illustrates a schematic view of a self-capacitance touch control structure using an exemplary touch panel surface touch recognition method according to the disclosed embodiments;

FIG. 3 illustrates a schematic view of self-capacitance touch control electrode arrangement used by an exemplary touch panel surface touch recognition method according to the disclosed embodiments;

FIG. 4 illustrates an expanded flow chart for certain step(s) in an exemplary touch panel surface touch recognition method according to the disclosed embodiments;

FIG. 5 illustrates an expanded flow chart for certain step(s) in another exemplary touch panel surface touch recognition method according to the disclosed embodiments;

FIG. 6 illustrates a flow chart of establishing a database to store relationship data in an exemplary touch panel surface touch recognition method according to the disclosed embodiments;

FIG. 7 illustrates a schematic view of an exemplary touch panel surface touch recognition system according to the disclosed embodiments;

FIG. 8 illustrates a schematic view of a recognition module in an exemplary touch panel surface touch recognition system according to the disclosed embodiments;

FIG. 9 illustrates a schematic view of another exemplary touch panel surface touch recognition system according to the disclosed embodiments;

FIG. 10 illustrates a schematic view of a setup module in an exemplary touch panel surface touch recognition system according to the disclosed embodiments;

FIG. 11 illustrates a schematic view of an exemplary touch panel used by various touch panel surface touch recognition methods according to the disclosed embodiments;

FIG. 12 illustrates a schematic view of touch surface area changes of exemplary soft and hard touches;

FIG. 13 illustrates a schematic view of touch surface area changes of exemplary hard and sliding touches;

FIG. 14 illustrates a flow chart of an exemplary touch panel surface touch recognition method according to the disclosed embodiments;

FIG. 15 illustrates a schematic view of touch surface area changes of exemplary touches;

FIG. 16 illustrates a schematic view of an exemplary setup for establishing a relationship database between touch surface area changes and touch pressure values; and

FIG. 17 illustrates a schematic view of another exemplary setup for establishing a relationship database between touch surface area changes and touch pressure values.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts. It should be understood that the exemplary embodiments described herein are only intended to illustrate and explain the present invention and not to limit the present invention.

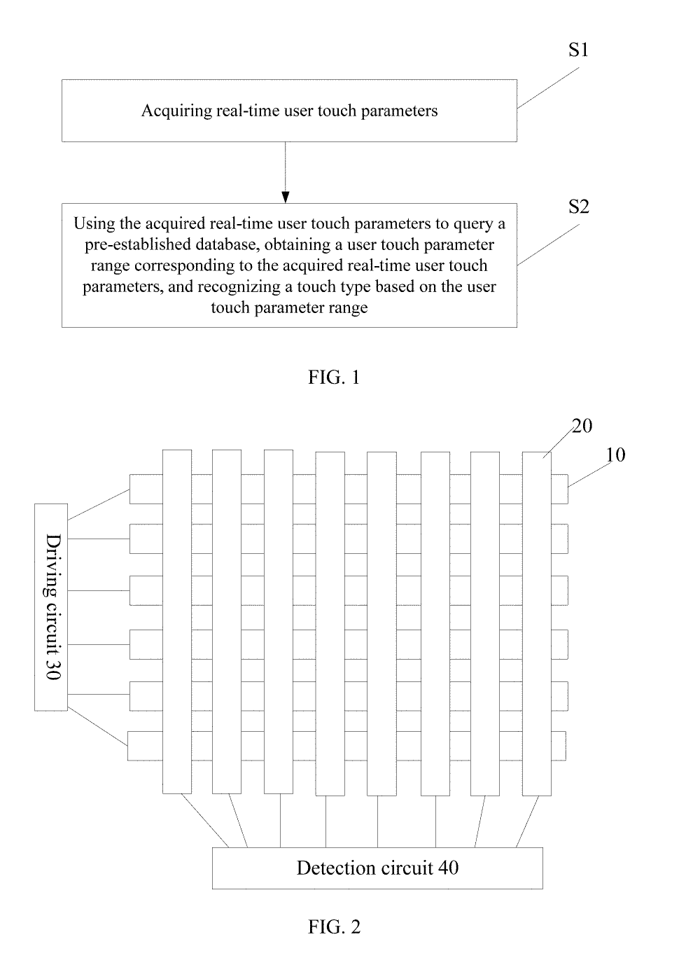

FIG. 1 illustrates a flow chart of an exemplary touch panel surface touch recognition method according to the present disclosure. Referring to FIG. 1, the touch panel surface touch recognition method includes the following steps.

Step S1: acquiring real-time user touch parameters.

In one embodiment, a touch control device may include a mutual-capacitance touch control structure. The touch control device may acquire real-time user touch parameters through the mutual-capacitance touch control structure.

FIG. 2 illustrates a schematic view of a mutual-capacitance touch control device using an exemplary touch panel surface touch recognition method according to the present disclosure. Referring to FIG. 2, the mutual-capacitance touch control device may include a plurality of driving electrodes 10, a plurality of detecting electrodes 20 intersecting with the plurality of the driving electrodes 10, a driving circuit 30 supplying driving signals to the driving electrodes 10, and a detection circuit 40 processing detecting signals from the detecting electrodes 20.

Specifically, the driving circuit 30 may periodically supply the driving signals to the driving electrodes 10. When a surface of the touch control device is touched by the user, the detecting signal transmitted by the detecting electrode 20 near the touch position may be affected by the user touch. Based on the detecting signal transmitted by the detecting electrode 20 near the touch position, the detection circuit 40 may detect or recognize whether and where the user touch occurs.

In another embodiment, the touch control device may include a self-capacitance touch control structure. The touch control device may acquire real-time user touch parameters through the self-capacitance touch control structure.

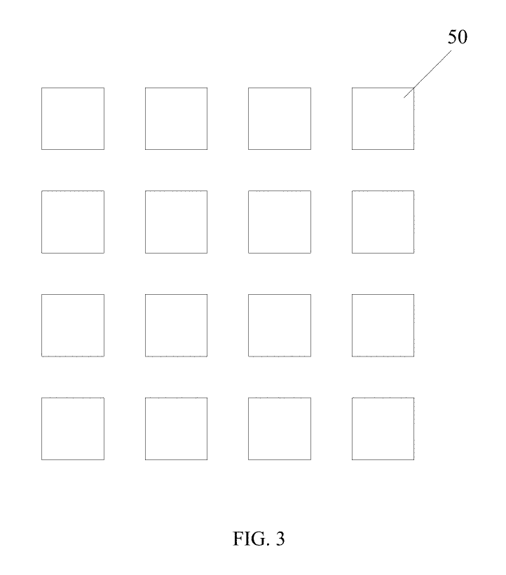

FIG. 3 illustrates a schematic view of self-capacitance touch control electrode arrangement using an exemplary touch panel surface touch recognition method according to the present disclosure. Referring to FIG. 3, the self-capacitance touch control structure may include a plurality of self-capacitance touch control electrodes 50 arranged in an array. The touch control device may recognize user touches on the surface of the touch control device through the signal changes of the self-capacitance touch control electrodes 50.

The present disclosure does not limit the touch control structure used in the touch control device. In certain embodiments, the touch control device may acquire the real-time user touch parameters through other types of the touch control structures as long as such touch control structures are able to obtain the real-time user touch parameters by detecting the touch control signals on the surface of the touch control device.

Returning to FIG. 1, the touch parameters may be provided to determine a touch type by the user on the surface of the touch control panel. The user touch types may include a first touch type and a second touch type. The first touch type may include a long touch or a hold, and a short touch or a tap, i.e., a touch type based on a duration of the touch. The long touch may last longer than the short touch. The second touch type may include a soft touch and a hard touch, i.e., a touch type based on a pressure or force of the touch. The soft touch may involve a touch pressure less than the hard touch.

In one embodiment, the user touch parameters may include a user touch duration and a plurality of user touch surface areas measured at different moments or time points during the user touch. The plurality of the measurement moments in the user touch duration may be pre-configured or randomly selected. The plurality of the measurement moments may be evenly distributed in the touch duration or distributed in other appropriate schemes.

Step S2: using the acquired real-time user touch parameters to query a pre-established database, obtaining a parameter range corresponding to the acquired real-time user touch parameters, and recognizing a touch type based on the user touch parameter range. The pre-established database may store the relationship data between the preconfigured touch types and the user touch parameter ranges corresponding to the pre-configured touch types. Different user touch parameter ranges may correspond to different pre-configured touch types.

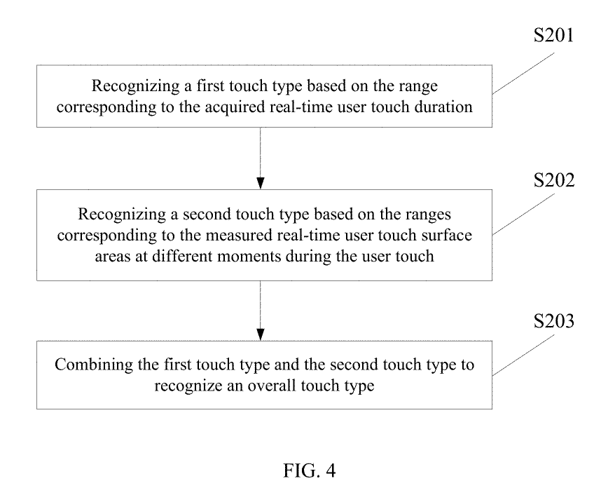

FIG. 4 illustrates an expanded flow chart for the second step in an exemplary touch panel surface touch recognition method according to the present disclosure. Referring to FIG. 4, in one embodiment, the procedure to recognize the user touch type based on the real-time user touch parameter ranges may include the following steps.

Step S201: based on the range corresponding to the acquired real-time user touch duration, recognizing a first touch type.

Specifically, in one embodiment, when the acquired real-time user touch duration is within the range of the touch duration range corresponding to the long touch, the user touch may be recognized as a long touch for the first touch type. When the acquired real-time user touch duration is within the range of the touch duration range corresponding to the short touch, the user touch may be recognized as a short touch for the first touch type.

Step S202: based on the ranges corresponding to the measured real-time user touch surface areas at different moments during the user touch, recognizing a second touch type.

In certain other embodiments, when the measured real-time user touch surface areas at different moments during the user touch are within the range of the user touch surface area corresponding to the hard touch, the user touch may be recognized as a hard touch for the second touch type. When the measured real-time user touch surface areas at different moments during the user touch are within the range of the user touch surface area corresponding to the soft touch, the user touch may be recognized as a soft touch for the second touch type.

Step S203: combining the first touch type and the second touch type to recognize an overall touch type.

Next, the first touch type and the second touch type may be combined to recognize one of long-soft touch, short-soft touch, long-hard touch, and short-hard touch as the overall touch type.

Further, when the measured real-time user touch surface areas at different moments during the user touch are within the range of the user touch surface area corresponding to the hard touch, the user touch may be recognized as a hard touch for the second touch type. When the measured real-time user touch surface area in at least one moment during the user touch is within the range of the user touch surface area corresponding to the hard touch, the user touch may be recognized as a hard touch for the second touch type.

In certain other embodiments, in addition to comparing the measured real-time user touch surface areas at different moments during the user touch with the range of the user touch surface area corresponding to the hard touch, a trend of the measured real-time user touch surface areas at different moments during the user touch may be used to recognize the second touch type. For example, when the measured real-time user touch surface areas at different moments during the user touch gradually increase chronologically and the maximum measured real-time user touch surface area at different moments during the user touch is with the range of the user touch surface area corresponding to the hard touch, the user touch may be recognized as a hard touch for the second touch type. Otherwise, the user touch may be recognized as a soft touch for the second touch type. Optionally, the measurement moments during the user touch may include the mid-point of the user touch duration. In the real product designs, the measurement moments during the user touch may or may not include the mid-point of the user touch duration.

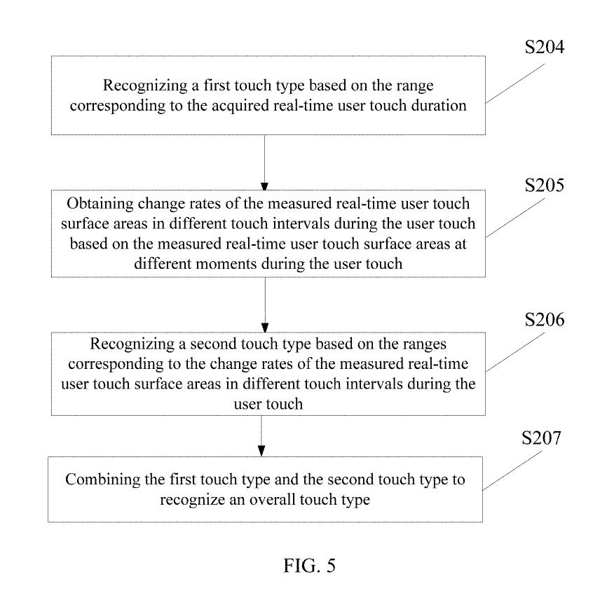

In another embodiment, the user touch parameters may also include a touch surface area change rate. FIG. 5 illustrates an expanded flow chart for the second step in another exemplary touch panel surface touch recognition method according to the present disclosure. Referring to FIG. 5, in one embodiment, the procedure to recognize the user touch type based on the real-time user touch parameter ranges may include the following steps.

Step S204: based on the range corresponding to the acquired real-time user touch duration, recognizing a first touch type.

Specifically, in one embodiment, when the acquired real-time user touch duration is within the range of the touch duration range corresponding to the long touch, the user touch may be recognized as a long touch for the first touch type. When the acquired real-time user touch duration is within the range of the touch duration range corresponding to the short touch, the user touch may be recognized as a short touch for the first touch type.

Step S205: based on the measured real-time user touch surface areas at different moments during the user touch, obtaining change rates of the measured real-time user touch surface areas in different touch intervals during the user touch.

Step S206: based on the ranges corresponding to the change rates of the measured real-time user touch surface areas in different touch intervals during the user touch, recognizing a second touch type.

In one embodiment, a time fraction elapsed between any two adjacent touch surface area measurement moments may be called a touch interval. Specifically, when at least one of the change rates of the measured real-time user touch surface areas in different touch intervals during the user touch is within a first pre-configured range, the user touch may be recognized as a hard touch for the second touch type. When all of the change rates of the measured real-time user touch surface areas in different touch intervals during the user touch is within a second pre-configured range, the user touch may be recognized as a soft touch for the second touch type.

Step S207: combining the first touch type and the second touch type to recognize an overall touch type.

Next, the first touch type and the second touch type may be combined to recognize one of long-soft touch, short-soft touch, long-hard touch, and short-hard touch as the overall touch type.

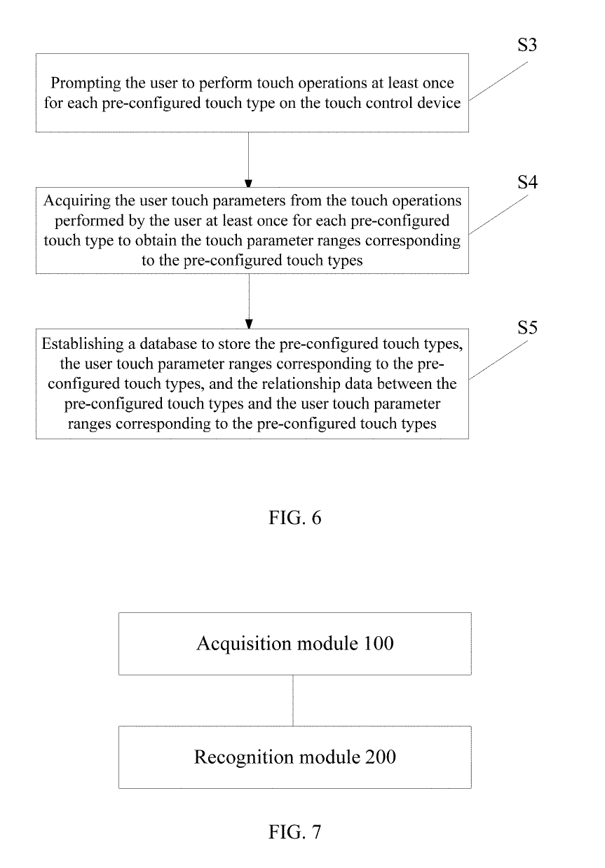

FIG. 6 illustrates a flow chart of establishing a database to store relationship data in an exemplary touch panel surface touch recognition method according to the present disclosure. Referring to FIG. 6, the procedure to establish a database to store relationship data may include the following steps.

Step S3: prompting the user to perform touch operations at least once for each pre-configured touch type on the touch control device.

Specifically, in one embodiment, the user may be prompted to perform the touch operations such as the long touch, the short touch, the soft touch, and the hard touch at least once on the touch control device.

Step S4: acquiring the user touch parameters from the touch operations performed by the user at least once for each pre-configured touch type to obtain the touch parameter ranges corresponding to the pre-configured touch types.

The user touch parameters of the touch operations performed by the user at least once for the long touch, the short touch, the soft touch, and the hard touch may be acquired to calculate the user touch parameter ranges corresponding to the long touch, the short touch, the soft touch, and the hard touch.

Step S5: based on the data sets of the pre-configured touch types and the corresponding user touch parameter ranges, establishing a database to store the pre-configured touch types, the user touch parameter ranges corresponding to the pre-configured touch types, and the relationship data between the pre-configured touch types and the user touch parameter ranges corresponding to the pre-configured touch types

A database may be established based on the relationship data between the long touch and the user touch parameter range corresponding to the long touch, the short touch and the user touch parameter range corresponding to the short touch, the soft touch and the user touch parameter range corresponding to the soft touch, and the hard touch and the user touch parameter range corresponding to the hard touch. The database may store the relationship data between the pre-configured touch types and the user touch parameter ranges corresponding to the pre-configured touch types, including the relationship data between the long touch and the user touch parameter range corresponding to the long touch, the short touch and the user touch parameter range corresponding to the short touch, the soft touch and the user touch parameter range corresponding to the soft touch, and the hard touch and the user touch parameter range corresponding to the hard touch.

In one embodiment, the user may be prompted to perform the touch operations at least once for the pre-configured touch types on the touch control device. The user may be prompted to perform a touch operation once for a pre-configured touch type on the touch control device. Accordingly, the user touch parameters of the touch operation performed by the user at least once for the pre-configured touch type may be acquired to obtain the user touch parameter range corresponding to the pre-configured touch type. Thus, the relationship data between the pre-configured touch type and the user touch parameter range corresponding to the pre-configured touch type.

Further, the pre-configured touch types may include, for example, the long touch, the short touch, the soft touch, and the hard touch. When a user touch duration corresponding to the long touch is T1 and a user touch duration corresponding to the short touch is T2, the user touch duration less than 2*T2 may correspond to the short touch, and the user touch duration greater than 0.5*T1 may correspond to the long touch. When 0.5*T1 and 2*T2 are crossed over or 0.5*T1 is less than or equal to 2*T2, the user touch duration may correspond to either the long touch or the short touch.

Alternatively, the arithmetic average of 0.5*T1 and 2*T2 may be called a first mid-point. The user touch duration greater than the first mid-point may correspond to the long touch. The user touch duration less than the first mid-point may correspond to the short touch. In certain other embodiments, other calculation methods may be used to differentiate between the long touch and the short touch.

Similarly, in another embodiment, a measured user touch surface area A1 may correspond to the soft touch, and a measured user touch surface area A2 may correspond to the hard touch. When all of the measured user touch surface areas at different moments during the user touch are between 0.8*A1 and 1.2*A1 or simply less than or equal to 1.2*A1, the user touch may be recognized as the soft touch. When at least one of the measured user touch surface areas at different moments during the user touch is between 0.8*A2 and 1.2*A2, the user touch may be recognized as the hard touch.

When 1.2*A1 and 0.8*A2 are crossed over or 1.2*A1 is greater than or equal to 0.8*A2, the user touch corresponding to the overlapped range may be recognized as either soft touch or the hard touch. Alternatively, the arithmetic average of 1.2*A1 and 0.8*A2 may be called a second mid-point. When at least one of the measured user touch surface areas at different moments during the user touch is greater than the second mid-point, the user touch may correspond to the hard touch. Otherwise, the user touch may correspond to the soft touch. In certain other embodiments, other calculation methods may be used to differentiate between the hard touch and the soft touch.

In another embodiment, a change rate V1 of the measured user touch surface area may correspond to the soft touch, and a change rate V2 of the measured user touch surface area may correspond to the hard touch. When the change rates of the measured user touch surface area in multiple intervals during the user touch are between 0.8*V1 and 1.2*V1 or simply less than or equal to 1.2*V1, the user touch may be recognized as the soft touch. When at least one of the change rates of the measured user touch surface area in different touch intervals during the user touch is between 0.8*V2 and 1.2*V2, the user touch may be recognized as the hard touch.

When 1.2*V1 and 0.8*V2 are crossed over or 1.2*V1 is greater than or equal to 0.8*V2, the user touch corresponding to the overlapped range may be recognized as either soft touch or the hard touch. Alternatively, the arithmetic average of 1.2*V1 and 0.8*V2 may be called a third mid-point. When at least one of the change rates of the measured user touch surface area in different touch intervals during the user touch is greater than the third mid-point, the user touch may correspond to the hard touch. Otherwise, the user touch may correspond to the soft touch. In certain other embodiments, other calculation methods may be used to differentiate between the hard touch and the soft touch.

In another embodiment, a measured user touch surface area A1 may correspond to the soft touch, a change rate V1 of the measured user touch surface area may correspond to the soft touch, a measured user touch surface area A2 may correspond to the hard touch, and a change rate V2 of the measured user touch surface area may correspond to the hard touch. When all of the measured user touch surface areas at different moments during the user touch are between 0.8*A1 and 1.2*A1 or simply less than or equal to 1.2*A1, and the change rates of the measured user touch surface area in multiple intervals during the user touch are between 0.8*V1 and 1.2*V1 or simply less than or equal to 1.2*V1, the user touch may be recognized as the soft touch. When at least one of the measured user touch surface areas at different moments during the user touch is between 0.8*A2 and 1.2*A2, and at least one of the change rates of the measured user touch surface area in different touch intervals during the user touch is between 0.8*V2 and 1.2*V2, the user touch may be recognized as the hard touch. The calculation method considering more than one range may improve the recognition precision.

In another embodiment, the procedure to prompt the user to perform touch operations at least once for each pre-configured touch type on the touch control device may include prompting the user to perform touch operations multiple times for each pre-configured touch type on the touch control device.

Accordingly, the procedure to acquire the user touch parameters from the touch operations performed by the user at least once for each pre-configured touch type to obtain for the touch parameter ranges corresponding to the pre-configured touch types may include acquiring the user touch parameters from each of the touch operations performed by the user multiple times for each pre-configured touch type to obtain the touch parameter ranges corresponding to the pre-configured touch types.

Averages and tolerances of the user touch parameters from each of the touch operations performed by the user multiple times for each pre-configured touch type may be calculated. The calculated averages and tolerances may be used for the user touch parameter range corresponding to each pre-configured touch type. The average and tolerance calculation procedures are well known, and are not described here.

The touch panel surface touch recognition method according to the present disclosure may eliminate the need for incorporating a deformation sensing module in the touch control device. Instead, the user touch parameters may be acquired during touch operations by the user. The measured user touch parameters may be used to query a pre-established database and recognize the touch type of the touch operation performed by the user. Thus, the touch recognition cost may be lowered, and the touch control device cost may be lowered as well.

Accordingly, the present invention also provides a touch recognition system for touch control devices. The touch recognition system may include any touch recognition method consistent with the disclosed embodiments.

FIG. 7 illustrates a schematic view of an exemplary touch panel surface touch recognition system according to the present disclosure. Referring to FIG. 7, the touch recognition system may include an acquisition module 100 to acquire real-time user touch parameters, and a recognition module 200 to use the acquired real-time user touch parameters to query a pre-established database, to obtain a parameter range corresponding to the acquired real-time user touch parameters, and to recognize a touch type based on the user touch parameter range.

Specifically, the database may store the relationship data between the pre-configured touch types and the user touch parameter ranges corresponding to the pre-configured touch types. Different user touch parameter ranges may correspond to different pre-configured touch types.

In one embodiment, the touch control device may include a mutual capacitance touch control structure. The touch control device may acquire the real-time user touch parameters through the mutual capacitance touch control structure. The mutual capacitance touch control structure may include a plurality of driving electrodes, a plurality of detecting electrodes intersecting with the plurality of the driving electrodes, a driver circuit supplying driving signals to the driving electrodes, and a detection circuit receiving and processing detecting signals from the detecting electrodes.

Specifically, the driver circuit may periodically supply the scanning signals to the driving electrodes. When the touch control device surface is touched by the user, the detecting signals from the detecting electrodes may change. The detecting signals received by the detection circuit from the detecting electrodes may be processed to recognize whether the touch control device surface is touched by the user.

In another embodiment, the touch control device may include a self-capacitance touch control structure. The touch control device may acquire the real-time user touch parameters through the self-capacitance touch control structure. The self-capacitance touch control structure may include a plurality of self-capacitance touch control electrodes arranged in an array. The detecting signal changes occurred near the self-capacitance touch control electrodes touched by the user may be used to detect the user touch on the touch control device surface. The real-time user touch parameters may be acquired.

In certain other embodiments, the touch control device may include other touch control structures to acquire the real-time user touch parameters as long as the detecting signals changes on the touch control device surface may be processed to acquire the real-time user touch parameters.

In one embodiment, the touch types may include a first touch type and a second touch type. The first touch type may include a long touch and a short touch. The touch duration corresponding to the long touch may be greater than the touch duration corresponding to the short touch. The second touch type may include a soft touch and a hard touch. The touch pressure corresponding to the soft touch may be smaller than the touch pressure corresponding to the hard touch.

In one embodiment, the user touch parameters may include a user touch duration and a plurality of measured touch surface areas at different moments during the user touch. The measurement moments during the user touch may be pre-configured or randomly selected in sequence. Optionally, the plurality of the measurement moments may be evenly distributed in the user touch duration. Other distributions may also be used.

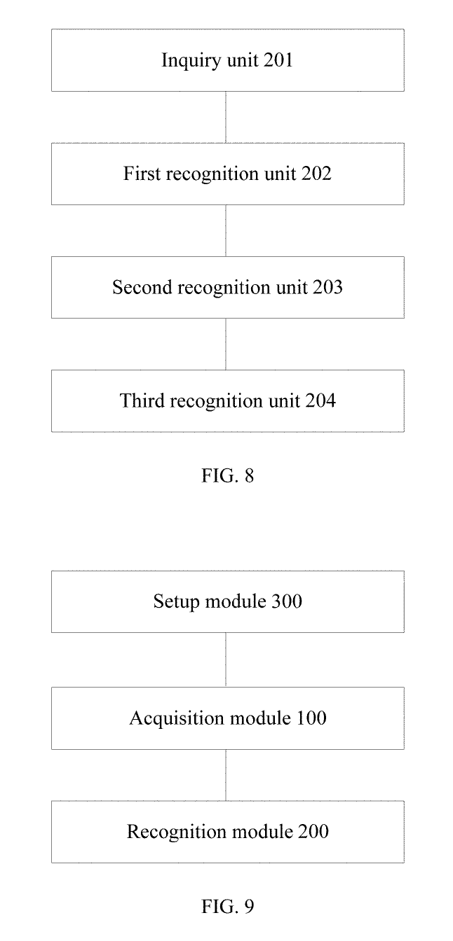

FIG. 8 illustrates a schematic view of a recognition module in an exemplary touch panel surface touch recognition system according to the present disclosure. In one embodiment, the recognition module 200 may include an inquiry unit 201, a first recognition unit 202, a second recognition unit 203, and a third recognition unit 204.

The inquiry unit 201 may be used to query the pre-established database with the user touch parameters acquired in real-time to obtain a range corresponding to the user touch parameters. The first recognition unit 202 may be used to recognize a first touch type based on the range corresponding to the user touch duration of the user touch parameters acquired in real-time. The second recognition unit 203 may be used to recognize a second touch type based on the range corresponding to the measured touch surface areas at different moments during the user touch of the user touch parameters acquired in real-time. The third recognition unit 204 may be used to recognize an overall touch type by combining the first touch type and the second touch type.

Specifically, in one embodiment, when the acquired real-time user touch duration is within the range of the touch duration range corresponding to the long touch, the user touch may be recognized as a long touch for the first touch type. When the acquired real-time user touch duration is within the range of the touch duration range corresponding to the short touch, the user touch may be recognized as a short touch for the first touch type.

In certain other embodiments, when the measured real-time user touch surface areas at different moments during the user touch are within the range of the user touch surface area corresponding to the hard touch, the user touch may be recognized as a hard touch for the second touch type. When the measured real-time user touch surface areas at different moments during the user touch are within the range of the user touch surface area corresponding to the soft touch, the user touch may be recognized as a soft touch for the second touch type.

Next, the first touch type and the second touch type may be combined to recognize one of long-soft touch, short-soft touch, long-hard touch, and short-hard touch as the overall touch type.

In certain embodiments, when multiple measured real-time user touch surface areas at different moments during the user touch are within the range of the user touch surface area corresponding to the hard touch, the user touch may be recognized as a hard touch for the second touch type. When at least one of the measured real-time user touch surface areas at different moments during the user touch is within the range of the user touch surface area corresponding to the hard touch, the user touch may be recognized as a hard touch for the second touch type.

In certain other embodiments, in addition to comparing the measured real-time user touch surface areas at different moments during the user touch with the range of the user touch surface area corresponding to the hard touch, a trend of the measured real-time user touch surface areas at different moments during the user touch may be used to recognize the second touch type. For example, when the measured real-time user touch surface areas at different moments during the user touch gradually increase chronologically and the maximum measured real-time user touch surface area at different moments during the user touch is with the range of the user touch surface area corresponding to the hard touch, the user touch may be recognized as a hard touch for the second touch type. Otherwise, the user touch may be recognized as a soft touch for the second touch type.

In another embodiment, the recognition module 200 may include an inquiry unit 201, a first recognition unit 202, a second recognition unit 203, and a third recognition unit 204.

The inquiry unit 201 may be used to query the pre-established database with the user touch parameters acquired in real-time to obtain a range corresponding to the user touch parameters. The first recognition unit 202 may be used to recognize a first touch type based on the range corresponding to the user touch duration of the user touch parameters acquired in real-time. The second recognition unit 203 may be used to obtain change rates of the touch surface area in different touch intervals during the user touch based on the touch surface areas at different moments during the user touch acquired in real-time and to recognize a second touch type based on the range corresponding to the change rates of the touch surface area in different touch intervals during the user touch. The third recognition unit 204 may be used to recognize an overall touch type by combining the first touch type and the second touch type.

In one embodiment, a time fraction elapsed between any two adjacent touch surface area measurement moments may be called a touch interval. Specifically, when at least one of the change rates of the measured real-time user touch surface areas in different touch intervals during the user touch is within a first pre-configured range, the user touch may be recognized as a hard touch for the second touch type. When all of the change rates of the measured real-time user touch surface areas in different touch intervals during the user touch is within a second pre-configured range, the user touch may be recognized as a soft touch for the second touch type.

FIG. 9 illustrates a schematic view of another exemplary touch panel surface touch recognition system according to the present disclosure. Referring to FIG. 9, in one embodiment, the touch recognition may further include a setup module 300. The setup module 300 may be used to set up a pre-established database. The pre-established database may store the relationship data between the pre-configured touch types and the user touch parameter ranges corresponding to the pre-configured touch types. Different user touch parameter ranges may correspond to different pre-configured touch types.

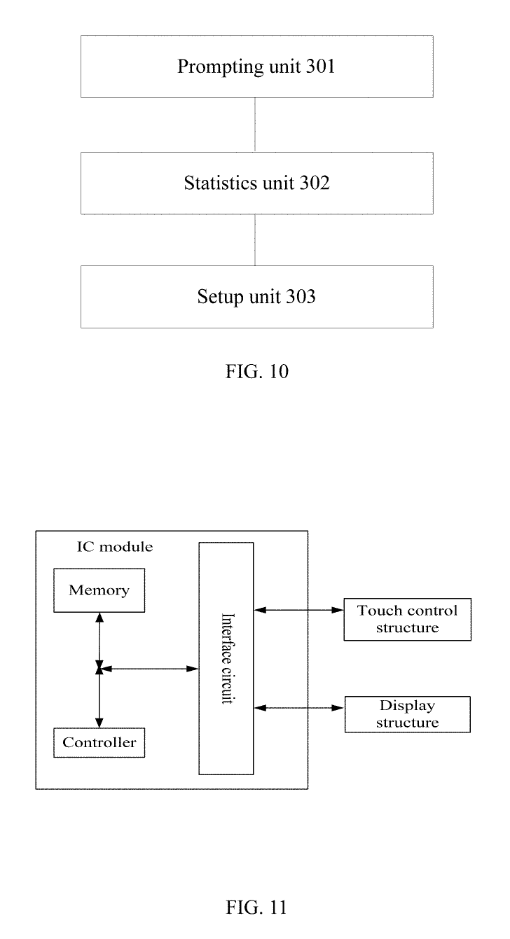

FIG. 10 illustrates a schematic view of a setup module in an exemplary touch panel surface touch recognition system according to the present disclosure. Referring to FIG. 10, the setup module 300 may include a prompting unit 301, a statistics unit 302, and a setup unit 303.

The prompting unit 301 may be used to prompt the user to perform touch operations at least once for each pre-configured touch type on the touch control device. The statistics unit 302 may be used to acquire the user touch parameters from the touch operations performed by the user at least once for each pre-configured touch type and to obtain the user touch parameter range corresponding to each pre-configured touch type. The setup unit 303 may be used to set up a database based on the pre-configured touch types and the user touch parameter ranges corresponding to the pre-configured touch types to store the relationship data between the pre-configured touch types and the user touch parameter ranges corresponding to the pre-configured touch types.

Specifically, in certain embodiments, the prompting unit 301 may be used to prompt the user to perform touch operations at least once for the long touch, the short touch, the soft touch, and the hard touch on the touch control device, respectively. The statistics unit 302 may be used to acquire the user touch parameters from the touch operations performed by the user at least once for the long touch, the short touch, the soft touch, and the hard touch respectively to obtain the touch parameter ranges corresponding to the long touch, the short touch, the soft touch, and the hard touch respectively.

The setup unit 303 may be used to establish a database to store the long touch and the corresponding user touch parameter range, the short touch and the corresponding user touch parameter range, the soft touch and the corresponding user touch parameter range, and the hard touch and the corresponding user touch parameter range, respectively. Specifically, the database may store the relationship data between the pre-configured touch types and the user touch parameter ranges corresponding to the pre-configured touch types. In other words, the database may store the relationship data between the long touch and the corresponding user touch parameter range, the short touch and the corresponding user touch parameter range, the soft touch and the corresponding user touch parameter range, and the hard touch and the corresponding user touch parameter range, respectively.

In one embodiment, the prompting unit 301 may be used to prompt the user to perform touch operations once for each pre-configured touch type on the touch control device. Accordingly, the statistics unit 302 may be used to acquire the user touch parameters from the touch operations performed by the user once for each pre-configured touch type to obtain the touch parameter range corresponding to each pre-configured touch type.

Further, the pre-configured touch types may include, for example, the long touch, the short touch, the soft touch, and the hard touch. When a user touch duration corresponding to the long touch is T1 and a user touch duration corresponding to the short touch is T2, the user touch duration less than 2*T2 may correspond to the short touch, and the user touch duration greater than 0.5*T1 may correspond to the long touch. When 0.5*T1 and 2*T2 are crossed over or 0.5*T1 is less than or equal to 2*T2, the user touch duration may correspond to either the long touch or the short touch.

Alternatively, the arithmetic average of 0.5*T1 and 2*T2 may be called a first mid-point. The user touch duration greater than the first mid-point may correspond to the long touch. The user touch duration less than the first mid-point may correspond to the short touch. In certain other embodiments, other calculation methods may be used to differentiate between the long touch and the short touch.

Similarly, in another embodiment, a measured user touch surface area A1 may correspond to the soft touch, and a measured user touch surface area A2 may correspond to the hard touch. When all of the measured user touch surface areas at different moments during the user touch are between 0.8*A1 and 1.2*A1 or simply less than or equal to 1.2*A1, the user touch may be recognized as the soft touch. When at least one of the measured user touch surface areas at different moments during the user touch is between 0.8*A2 and 1.2*A2, the user touch may be recognized as the hard touch.

When 1.2*A1 and 0.8*A2 are crossed over or 1.2*A1 is greater than or equal to 0.8*A2, the user touch corresponding to the overlapped range may be recognized as either soft touch or the hard touch. Alternatively, the arithmetic average of 1.2*A1 and 0.8*A2 may be called a second mid-point. When at least one of the measured user touch surface areas at different moments during the user touch is greater than the second mid-point, the user touch may correspond to the hard touch. Otherwise, the user touch may correspond to the soft touch. In certain other embodiments, other calculation methods may be used to differentiate between the hard touch and the soft touch.

In another embodiment, a change rate V1 of the measured user touch surface area may correspond to the soft touch, and a change rate V2 of the measured user touch surface area may correspond to the hard touch. When the change rates of the measured user touch surface area in multiple intervals during the user touch are between 0.8*V1 and 1.2*V1 or simply less than or equal to 1.2*V1, the user touch may be recognized as the soft touch. When at least one of the change rates of the measured user touch surface area in different touch intervals during the user touch is between 0.8*V2 and 1.2*V2, the user touch may be recognized as the hard touch.

When 1.2*V1 and 0.8*V2 are crossed over or 1.2*V1 is greater than or equal to 0.8*V2, the user touch corresponding to the overlapped range may be recognized as either soft touch or the hard touch. Alternatively, the arithmetic average of 1.2*V1 and 0.8*V2 may be called a third mid-point. When at least one of the change rates of the measured user touch surface area in different touch intervals during the user touch is greater than the third mid-point, the user touch may correspond to the hard touch. Otherwise, the user touch may correspond to the soft touch. In certain other embodiments, other calculation methods may be used to differentiate between the hard touch and the soft touch.

In another embodiment, a measured user touch surface area A1 may correspond to the soft touch, a change rate V1 of the measured user touch surface area may correspond to the soft touch, a measured user touch surface area A2 may correspond to the hard touch, and a change rate V2 of the measured user touch surface area may correspond to the hard touch. When all of the measured user touch surface areas at different moments during the user touch are between 0.8*A1 and 1.2*A1 or simply less than or equal to 1.2*A1, and the change rates of the measured user touch surface area in multiple intervals during the user touch are between 0.8*V1 and 1.2*V1 or simply less than or equal to 1.2*V1, the user touch may be recognized as the soft touch. When at least one of the measured user touch surface areas at different moments during the user touch is between 0.8*A2 and 1.2*A2, and at least one of the change rates of the measured user touch surface area in different touch intervals during the user touch is between 0.8*V2 and 1.2*V2, the user touch may be recognized as the hard touch. The calculation method considering more than one range may improve the recognition precision.

In another embodiment, the prompting unit 301 may be used to prompt the user to perform touch operations multiple times for each pre-configured touch type on the touch control device. Accordingly, the statistics unit 302 may be used to acquire the user touch parameters from the touch operations performed by the user multiple times for each pre-configured touch type to obtain the touch parameter ranges corresponding to the pre-configured touch types.

The user touch parameters from the touch operations performed by the user multiple times for each pre-configured touch type may be calculated to obtain the averages and the tolerances. The calculated averages and tolerances may be used for the user touch parameter ranges corresponding to each pre-configured touch type. The average and tolerance calculation procedures are well known, and are not described here.

The touch panel surface touch recognition method according to the present disclosure may eliminate the need for incorporating a deformation sensing module in the touch control device. Instead, the user touch parameters may be acquired during touch operations by the user. The measured user touch parameters may be used to query a pre-established database and recognize the touch type of the touch operation performed by the user. Thus, the touch recognition cost may be lowered, and the touch control device cost may be lowered as well.

FIG. 11 illustrates a schematic view of an exemplary touch panel used by various touch panel surface touch recognition methods according to the present disclosure. Referring to FIG. 11, the touch panel may include a touch control structure, a display structure, a controller, a memory, and an interface circuit. The controller, the memory, and the interface circuit may also be referred to as an integrated circuit module or IC module, which controls the operations of the touch control structure and the display structure. In addition, the IC module may also carry out the operational procedures of various touch panel surface touch recognition methods according the disclosed embodiments. Other components may also be included.

The touch panel may be configured to implement the above-described methods and systems for recognizing the touch types. In addition, other optional or alternative schemes of surface touch recognition may also be implemented as follows.

During operation, a user may touch the touch panel surface. The touch control structure may detect corresponding touch control signals and may transmit the touch control signals to the controller through the interface circuit. The controller may analyze the touch control signals to determine whether the characteristics of a hard touch are included in the touch control signals.

In addition to have a larger touch pressure than the soft touch, the hard touch may also last longer than the soft touch. The hard touch may start with a small initial touch surface area and may reach a maximum touch surface area that is substantially larger than the initial touch surface area. The soft touch may reach a maximum touch surface area that is not substantially larger than the initial touch surface area. The hard touch may not move substantially away from the initial touch surface area. The soft touch may move substantially away from the initial touch surface area. When the soft touch moves substantially away from the initial touch surface area, such soft touch may also be called a sliding touch. Thus, when a user touch lasts longer than a certain time threshold, does not reach a maximum that is substantially larger than the initial touch surface area, and does not move substantially away from the initial touch surface area, such user touch may be recognized as a hard touch.

When all three characteristics of a hard touch are detected based on the touch control signals, the user touch may be recognized as a hard touch. Otherwise, the user touch may be not recognized as a hard touch.

In one embodiment, a soft touch may last less than about 1 second, and a hard touch may last at least about 0.5 seconds. Based on the user touch duration, the user touch may be recognized as either a soft touch or a hard touch. When the user touch duration is between about 0.5 seconds and 1 second, the user touch may be recognized as either a soft touch or a hard touch.

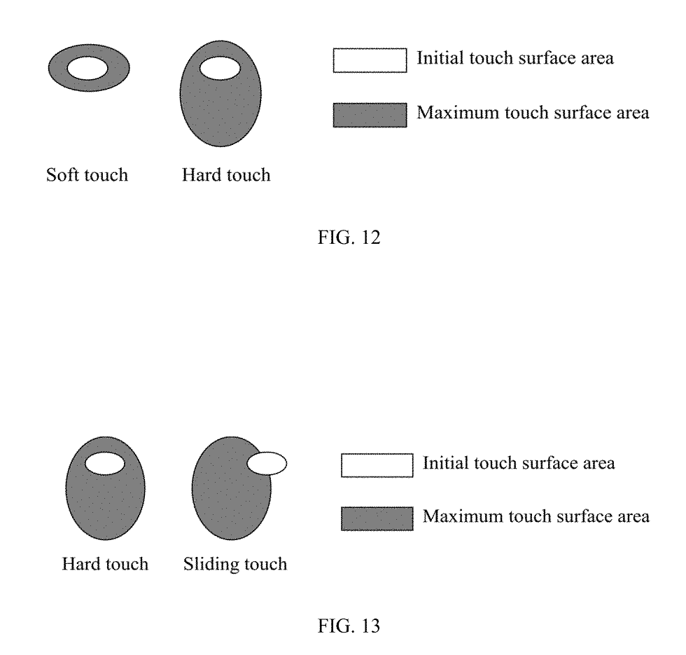

FIG. 12 illustrates a schematic view of touch surface area changes of exemplary soft and hard touches. Referring to FIG. 12, the touch surface area may change during the user touch. When the user touches a touch panel surface, the user may touch the touch panel surface with a small initial touch surface area. In the user touch duration, the touch surface area may increase as the touch pressure increases. The harder the user presses, the larger the touch surface area. When the user touch approaches its completion, the touch surface area may decrease and may eventually decrease to zero. The hard touch may start with a small initial touch surface area and may reach a maximum touch surface area that is substantially larger than the initial touch surface area. The soft touch may reach a maximum touch surface area that is not substantially larger than the initial touch surface area.

FIG. 13 illustrates a schematic view of touch surface area changes of exemplary hard and sliding touches. Referring to FIG. 13, the touch surface area may move during the user touch. The hard touch may not move substantially away from the initial touch surface area, and the initial touch surface area may be entirely included inside the maximum touch surface area. The sliding touch may move substantially away from the initial touch surface area, and the initial touch surface area may not be entirely included inside the maximum touch surface area. When a user touch moves substantially away from the initial touch surface area, and the initial touch surface area is not entirely included inside the maximum touch surface area, such user touch may be recognized as a sliding touch, instead of a hard touch.

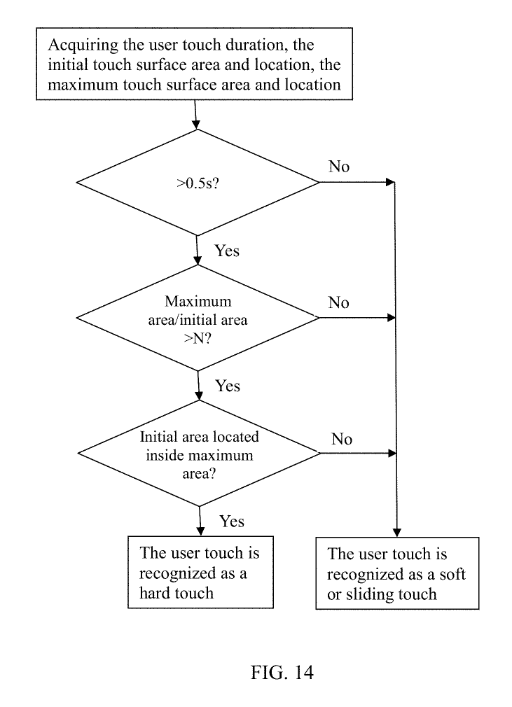

FIG. 14 illustrates a flow chart of an exemplary touch panel surface touch recognition method according to the present disclosure. Referring to FIG. 14, the touch recognition method may start by acquiring the user touch duration, the initial touch surface area and location, and the maximum touch surface area and location. The user touch duration may be compared against 0.5 second or other appropriate threshold value. When the user touch duration is greater than about 0.5 seconds, the maximum touch surface area may be compared against N times the initial touch surface area, where N is a threshold value, such as an empirical number, and may be obtained through large number of tests. When the maximum touch surface area is greater than N times the initial touch surface area, the location of the initial touch surface area may be checked against the maximum touch surface area. When the initial touch surface area is located inside the maximum touch surface area, the user touch may be recognized a hard touch. Otherwise, the user touch may not be recognized as a hard touch.

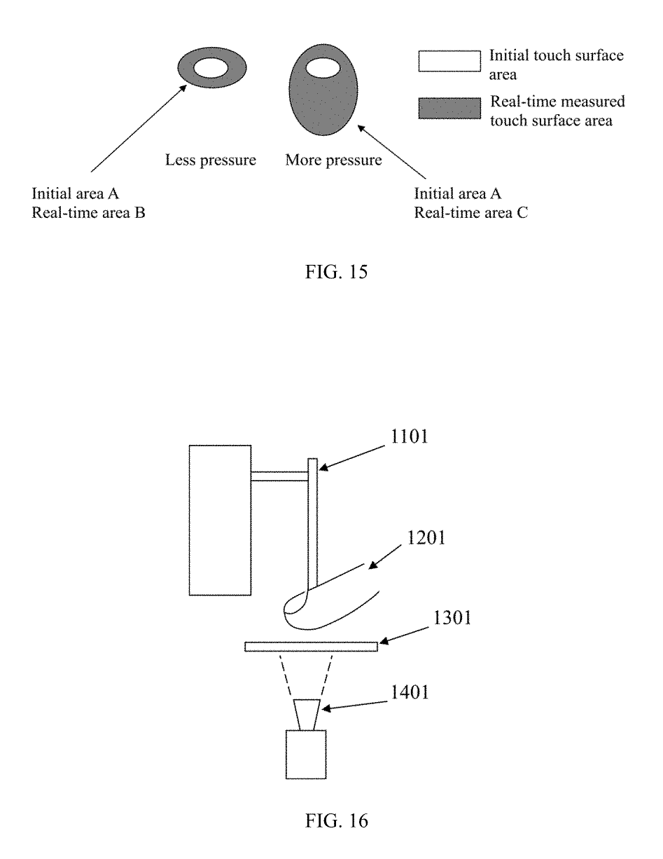

FIG. 15 illustrates a schematic view of touch surface area changes of exemplary touches. Referring to FIG. 15, the touch recognition method according to the present disclosure may calculate a ratio of the real-time measured touch surface area over the initial touch surface area. The ratio may represent the magnitude of the touch, which may be used to recognize a soft touch or a hard touch. At the same time, the touch recognition method may also calculate a sliding path of the touch, i.e., the direction of the touch. When both the magnitude and the direction of the touch are obtained, the touch recognition method may be able to simulate drawing by a brushstroke type touch.

By performing large number of tests, a relationship database between the ratios of the real-time measured touch surface areas and the initial touch surface areas and the magnitudes of the touches. The table below may be such an example.

| Initial touch | Real-time measured | | Touch |
|---|---|---|---|
| surface area | touch surface area | Ratio | pressure (N) |
| A0 | A1 | A1/A0 | N1 |
| A0 | A2 | A2/A0 | N2 |
| . . . | . . . | . . . | . . . |
| A0 | An | An/A0 | Nn |

In one embodiment, the database table may be stored in the IC module or other appropriate memory. The IC module may query the database table to retrieve the touch pressures or the magnitudes of the touches based on the ratio/force relationship. A ratio-force curve may also be established based on the database table to obtain continuous values of touch pressure based on real-time area ratio calculated.

FIG. 16 illustrates a schematic view of an exemplary setup for establishing a relationship database between touch surface area changes or ratios and touch pressure values. Referring to FIG. 16, the setup may be used to perform large number of tests to establish a relationship database between touch surface area changes and touch pressure values. The setup may include an adjustable pressing device 1101, a dummy finger 1201, a sheet of glass 1301, and a camera or video recorder 1401.

The adjustable pressing device 1101 may be configured to apply a certain pressure on the dummy finger 1201. The dummy finger 1201 may press the sheet of glass 1301. The camera 1401 may capture the touch surface area occupied by the dummy finger 1201 on the sheet of glass 1301. The adjustable pressing device 1101 may adjust and apply a different pressure on the dummy finger 1201. The camera 1401 may again capture the touch surface area occupied by the dummy finger 1201 on the sheet of glass 1301. The tests may be repeated to obtain a large number of the touch pressures and the corresponding touch surface areas. The test data may form the relationship database between touch surface area changes and touch pressure values.

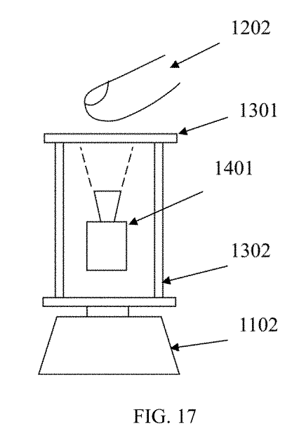

FIG. 17 illustrates a schematic view of another exemplary setup for establishing a relationship database between touch surface area changes and touch pressure values. Referring to FIG. 17, the setup may be used to perform large number of tests to establish a relationship database between touch surface area changes and touch pressure values. The setup may include a pressure sensing device 1102, a human finger 1202, a sheet of glass 1301, a camera or video recorder 1401, and a support frame 1302.

The human finger 1202 may apply a certain pressure on the sheet of glass 1301. The camera 1401 may capture the touch surface area occupied by the human finger 1202 on the sheet of glass 1301. The pressure sensing device 1102 may record the touch pressure. The human finger 1202 may apply a different pressure on the sheet of glass 1301. The camera 1401 may again capture the touch surface area occupied by the human finger 1202 on the sheet of glass 1301. The pressure sensing device 1102 may again record the touch pressure. The tests may be repeated to obtain a large number of the touch pressures and the corresponding touch surface areas. The test data may form the relationship database between touch surface area changes and touch pressure values.

Various embodiments have been described to illustrate the operation principles and exemplary implementations. The embodiments disclosed herein are exemplary only. Other applications, advantages, alternations, modifications, or equivalents to the disclosed embodiments are obvious to those skilled in the art and are intended to be encompassed within the scope of the present disclosure.

What is claimed is:

1. A touch panel surface touch recognition method for a touch control device, comprising:
acquiring real-time user touch parameters of a user touch;
using the acquired real-time user touch parameters to query a pre-established database to obtain a user touch parameter range corresponding to the acquired real-time user touch parameters; and
recognizing an overall touch type of the user touch based on the user touch parameter range,
wherein the pre-established database stores relationship data between pre-configured user touch types and user touch parameter ranges corresponding to the pre-configured user touch types; and different user touch parameter ranges correspond to different pre-configured touch types.

2. The touch recognition method of claim 1, wherein:
the user touch types include a first touch type and a second touch type;
the first touch type includes a long touch and a short touch, wherein a touch duration corresponding to the long touch is greater than a user touch duration corresponding to the short touch; and
the second touch type includes a soft touch and a hard touch, wherein a touch pressure corresponding to the soft touch is smaller than a touch pressure corresponding to the hard touch.

3. The touch recognition method of claim 2, wherein:
the user touch parameters include a duration of the user touch and touch surface areas measured in real-time at different moments during the user touch.

4. The touch recognition method of claim 3, wherein recognizing the user touch type based on the user touch parameter ranges further includes:
recognizing the first touch type of the user touch based on the user touch parameter range corresponding to the touch duration;
recognizing the second touch type of the user touch based on the user touch parameter range corresponding to user touch surface areas measured in real-time at different moments during the user touch; and
combining the first touch type and the second touch type to recognize the overall touch type of the user touch.

5. The touch recognition method of claim 3, wherein the user touch parameters also include a change rate of a user touch surface area, and recognizing the user touch type based on the user touch parameter ranges further includes:
recognizing the first touch type of the user touch based on the user touch parameter range corresponding to the touch duration;
obtaining change rates of user touch surface areas measured in real-time in different touch intervals during the user touch based on the user touch surface areas measured in real-time at different moments during the user touch;
recognizing the second touch type based on ranges corresponding to the change rates of the user touch; and
combining the first touch type and the second touch type to recognize the overall touch type of the user touch.

6. The touch recognition method of claim 1, wherein the pre-established database is established by:
prompting the user to perform touch operations at least once for each pre-configured user touch type on the touch control device;
acquiring the user touch parameters from the touch operations performed by the user at least once for each pre-configured touch type to obtain the touch parameter ranges corresponding to the pre-configured user touch types; and
establishing a database to store the pre-configured user touch types, the user touch parameter ranges corresponding to the pre-configured user touch types, and the relationship data between the pre-configured user touch types and the user touch parameter ranges corresponding to the pre-configured user touch types.

7. The touch recognition method of claim 6, wherein:
prompting the user to perform touch operations at least once for each pre-configured user touch type on the touch control device further includes:
prompting the user to perform the touch operations multiple times for each pre-configured user touch type on the touch control device; and
acquiring the user touch parameters from the touch operations performed by the user further includes:
acquiring the user touch parameters from each of the touch operations performed by the user multiple times for each pre-configured user touch type; and
calculating averages and tolerances of the user touch parameters acquired from each of the touch operations performed by the user multiple times for each pre-configured user touch type to obtain the touch parameter ranges corresponding to the pre-configured user touch types.

8. A touch panel surface touch recognition system for a touch control device, comprising:
an acquisition module configured to acquire real-time user touch parameters of a user touch;
a recognition module configured to use the acquired real-time user touch parameters to query a pre-established database and to obtain a user touch parameter range corresponding to the acquired real-time user touch parameters; and to recognize an overall touch type of the user touch based on the user touch parameter range,
wherein the pre-established database stores relationship data between pre-configured user touch types and user touch parameter ranges corresponding to the pre-configured user touch types; and different user touch parameter ranges correspond to different pre-configured touch types.

9. The touch recognition system of claim 8, wherein:
the user touch types include a first touch type and a second touch type;
the first touch type includes a long touch and a short touch, wherein a touch duration corresponding to the long touch is greater than a user touch duration corresponding to the short touch; and
the second touch type includes a soft touch and a hard touch, wherein a touch pressure corresponding to the soft touch is smaller than a touch pressure corresponding to the hard touch.

10. The touch recognition system of claim 9, wherein:
the user touch parameters include a duration of the user touch and touch surface areas measured in real-time at different moments during the user touch.

11. The touch recognition system of claim 9, wherein the recognition module further includes:
an inquiry unit configured to query the pre-established database with the user touch parameters acquired in real-time to obtain a range corresponding to the user touch parameters;
a first recognition unit configured to recognize the first touch type of the user touch based on the user touch parameter range corresponding to the touch duration;
a second recognition unit configured to recognize the second touch type of the user touch based on the user touch parameter range corresponding to user touch surface areas measured in real-time at different moments during the user touch; and
a third recognition unit configured to recognize the overall touch type by combining the first touch type and the second touch type.

12. The touch recognition system of claim 9, wherein:
the user touch parameters also include a change rate of a user touch surface area of a user touch surface area measured in real-time; and
the recognition module includes:
an inquiry unit configured to query the pre-established database with the user touch parameters to obtain a range corresponding to the user touch parameters;
a first recognition unit configured to recognize the first touch type of the user touch based on the user touch parameter range corresponding to the touch duration;
a second recognition unit configured to obtain change rates of user touch surface areas measured in real-time in different touch intervals during the user touch based on user touch surface areas measured in real-time at different moments during the user touch and to recognize the second touch type based on ranges corresponding to the change rates of the user touch; and
a third recognition unit configured to recognize the overall touch type by combining the first touch type and the second touch type.

13. The touch recognition system of claim 8, further including:
a setup module configured to set up the pre-established database, wherein the pre-established database stores the pre-configured user touch types, the user touch parameter ranges corresponding to the pre-configured user touch types, and the relationship data between the pre-configured user touch types and the user touch parameter ranges corresponding to the pre-configured user touch types.

14. The touch recognition system of claim 13, wherein the setup module includes:
a prompting unit configured to prompt the user to perform touch operations at least once for each pre-configured user touch type on the touch control device;
a statistics unit configured to acquire the user touch parameters from the touch operations performed by the user at least once for each pre-configured touch type to obtain the touch parameter ranges corresponding to the pre-configured user touch types; and
a setup unit configured to set up a database store the pre-configured user touch types, the user touch parameter ranges corresponding to the pre-configured user touch types, and the relationship data between the pre-configured user touch types and the user touch parameter ranges corresponding to the pre-configured user touch types.

15. The touch recognition method of claim 14, wherein:
the prompting unit is further configured to prompt the user to perform the touch operations multiple times for each pre-configured user touch type on the touch control device; and
the statistics unit is further configured to acquire the user touch parameters from each of the touch operations performed by the user multiple times for each pre-configured user touch type, and to calculate averages and tolerances of the user touch parameters acquired from each of the touch operations performed by the user multiple times for each pre-configured user touch type to obtain the touch parameter ranges corresponding to the pre-configured user touch types.
